(19) United States
(12) Patent Application Publication
(10) Pub. No.: US 2012/0252371 A1
(43) Pub. Date: Oct. 4, 2012

(54) METHOD, SYSTEM AND APPARATUS FOR REMOTE INTERFERENCE MONITORING AND ANALYSIS

(75) Inventor: CONSTANTIN PINTILEI, MONTREAL (CA)

(73) Assignee: LINEAR HERTZ INC., MONTREAL (CA)

(21) Appl. No.: 13/416,536

(22) Filed: Mar. 9, 2012

Related U.S. Application Data
(60) Provisional application No. 61/468,667, filed on Mar. 29, 2011.

(51) Int. Cl. H04W 24/08

(52) U.S. Cl. 455/67.13

(57) ABSTRACT

A method, system and apparatus for monitoring and analyzing interference in a source of RF signals is disclosed. The apparatus comprises a first display for presenting a frequency spectrum of the collected signals over a frequency band and at a display time within a time frame and a second display for presenting a time domain representation of the signals over the time frame and for a display frequency within the frequency band where modification of the display frequency results in the time domain representation being simultaneously updated and modification of the display time results in the frequency spectrum being simultaneously updated. The system comprises monitoring devices each comprising a monitoring unit and a network interface for transmitting RF signals to a server system comprising and a plurality of analysis tools.

### CROSS REFERENCE TO RELATED APPLICATIONS

This application claims priority from U.S. provisional application Ser. No. 61/468,667 filed on Mar. 29, 2011 and which is incorporated herein in its entirety by reference.

### FIELD OF THE INVENTION

The present invention relates to a method, system and apparatus for remote interference monitoring and analysis.

### BACKGROUND OF THE INVENTION

One problem which arises with systems such as Wifi, cell phones, land mobile radio and the like that transmit data to and from a large number of customers via wireless radio frequency connections is that they are often subject to interference. Such interference can arise from external sources, the result of random fluctuations in signals due to fading and the like, adjacent channel interference from other transmitters in the system, etc. A signal in the presence of interference will often be degraded thereby reducing the overall performance of the communication system.

In order to address interference, the prior art discloses systems and protocols which tolerate moderate levels of interference with only minimal affect on performance. In many cases, however, such prior systems are insufficient. One other method is to determine the source of the interference using monitoring equipment such that steps can be taken to reduce the interference from that source, or eliminate it.

In order to monitor interference, the prior art discloses methods and systems comprising self contained units which are transported to the site in order to gather and analyze the source of interference. One drawback of such units is that they are expensive. Another drawback is that they typically require a technician to be present at the site in order to analyze the measured interference.

### SUMMARY OF THE INVENTION

In order to address the above and other drawbacks, and in accordance with the present invention, there is provided an apparatus for analyzing and monitoring interference in a source of radio frequency (RF) signals. The apparatus comprises a monitoring device comprising an antenna and spectrum analyzer for collecting a series of RF signals within a frequency band and over a time frame from the source of RF signals, data storage for storing the collected RF signals, a first display for presenting a frequency spectrum of the collected RF signals over the frequency band and at a display time within the time frame, a second display for presenting a time domain representation of the collected RF signals over the time frame and for a display frequency within the frequency band, and an interface for modifying one of the display frequency and the display time. Modification of the display frequency results in the time domain representation being accordingly updated and modification of the display time results in the frequency spectrum being accordingly updated.

There is also provided a method for analyzing and monitoring interference in a source of radio frequency (RF) signals. The method comprises collecting and storing RF signals within a frequency band and over a time frame, presenting on a first display a frequency spectrum of the stored RF signals over the frequency band and at a display time within the time frame, presenting on a second display a time domain representation of the stored RF signals over the time frame and for a display frequency within the frequency band, locating one of a frequency of interest and a time of interest and accordingly modifying one of the display frequency to the frequency of interest and the display time to the time of interest. Modification of the display frequency results in the time domain representation being accordingly updated and modification of the display time results in the frequency spectrum being accordingly updated.

Additionally there is provided a system for monitoring and analyzing interference in a source of RF signals. The system comprises at least one monitoring device, each monitoring device comprising an antenna and a spectrum analyzer for collecting a series of RF signals from the source of RF signals over a time frame and within a frequency band, a processor for time stamping the collected series of RF signals and a network interface for transmitting the time stamped series of RF signals to a server system, the server system comprising a data services part comprising a databank for storing the time stamped series of RF signals and a web services part comprising a web interface comprising a plurality of analysis tools, and at least one user system, the user system comprising a web browser for accessing the server system using the web interface for accessing at least one of the plurality of analysis tools for analyzing a respective series of the time stamped series of RF signals stored in the databank.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a block diagram of a system for remote interference monitoring and analysis in accordance with an illustrative embodiment of the present invention;

FIG. 2 is a block diagram of a monitoring unit in accordance with an illustrative embodiment of the present invention;

FIG. 3 is a block diagram of a server system in accordance with an illustrative embodiment of the present invention;

FIGS. 4A and 4B provide graphical interface views of respectively a spectrum analyzer tool and a trace analyzer tool in accordance with an illustrative embodiment of the present invention;

FIGS. 5A through 5E provide examples of a user interface in accordance with an illustrative embodiment of the present invention; and

FIG. 6 is a flow chart of a typical sequence of operations in accordance with an illustrative embodiment of the present invention.

### DESCRIPTION OF ILLUSTRATIVE EMBODIMENTS

The present invention is illustrated in further details by the following non-limiting examples.

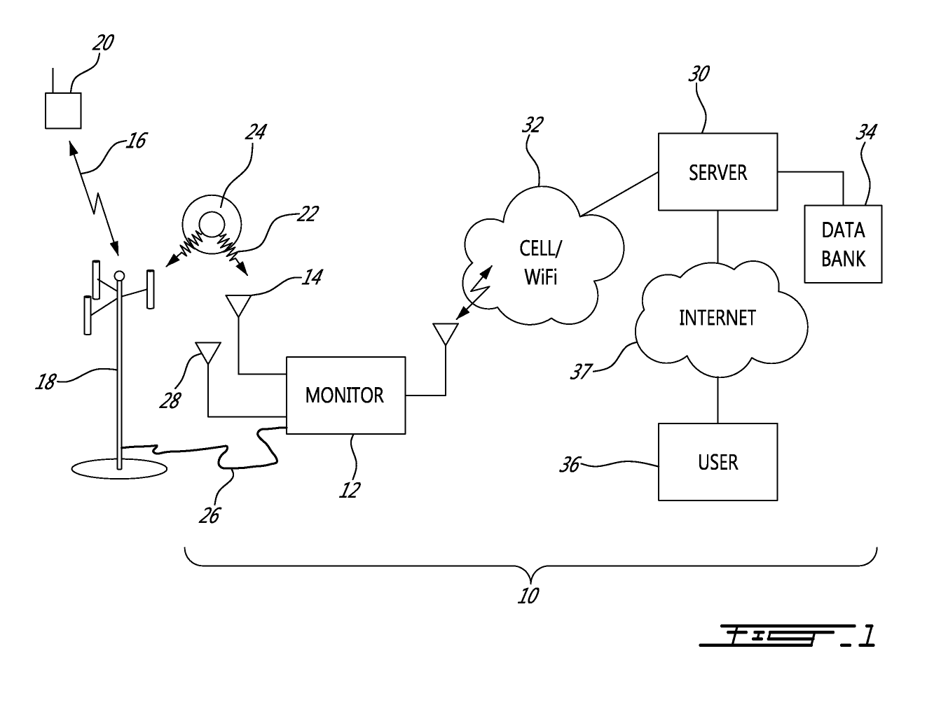

Referring now to FIG. 1, a remote interference monitoring and analysis system, generally referred to by the reference numeral 10, will be described. The system 10 comprises a monitoring unit 12 comprising a first antenna 14 for capturing transmissions 16 between, for example, a communications tower 18 and, typically a plurality, of mobile devices as in 20, as well as interference 22 generated by an interference source 24. As shown, the interference 22 can be captured either using the antenna 14 over the air or, alternately, from a monitoring port of the communications tower, for example via a coaxial cable 26. In this regard, the coaxial cable 26 provides an alternate source for capturing transmissions, interference and the like.

A second antenna 28 is also illustratively provided for capturing the content of transmissions 16 between the communications tower 18 and a mobile device 20. The interference 22 degrades the transmissions 16 used to communicate between the communications tower 18 and the mobile device 20 such that the performance of the communications between tower 18 and mobile device 20 is suboptimal. The monitoring unit 12 is in turn connected to a server system 30 illustratively via a wireless connection 32 such as a cellular modem or, if available, a WiFi connection or the like. The server system 30, which also comprises a databank 34, is in turn interconnected with a user 36, for example via a PC or the like, via a broadband connection 37, such as the Internet. It should be noted that although the monitoring unit 12/server system 30 connection is shown as being a wireless connection 32, in a particular embodiment all, or at least part, of this connection would typically be provided by the Internet.

Still referring to FIG. 1, in operation, the monitoring unit 12 captures radio frequency (RF) signals and transmissions received at the antennas 14, 28 and provides these from time to time to the server system 30 which illustratively stores the recorded signals within the databank 34. As will be discussed in more detail below, the server system 30 also provides the user 36 access to at least a portion of the recorded signals stored in the databank 34 for analysis.

Still referring to FIG. 1, typically a plurality of monitoring units as in 12 would be deployed within the system 10 for monitoring interference at various locations and for various users as in 36 with different needs. For example, a first user as in 36 might be interested in monitoring/analyzing interference in a smaller Wifi system, for example at an Internet café or the like. A second user as in 36, on the other hand, might be interested in monitoring/analyzing interference in a larger cellular system. A third user as in 36 might be interested in monitoring/analyzing interference in another land mobile system. Monitoring data of each of these monitoring units as in 12 transmitted for storage within the server system 30 and access to one of a plurality of users as in 36. Of note is that, in a particular embodiment, the monitoring unit 12 may be equipped with particular antennas 14, 28 and other equipment in order to capture RF signals and transmissions of particular wireless communication systems using particular frequency bands, modulation methods, transmission protocols and the like.

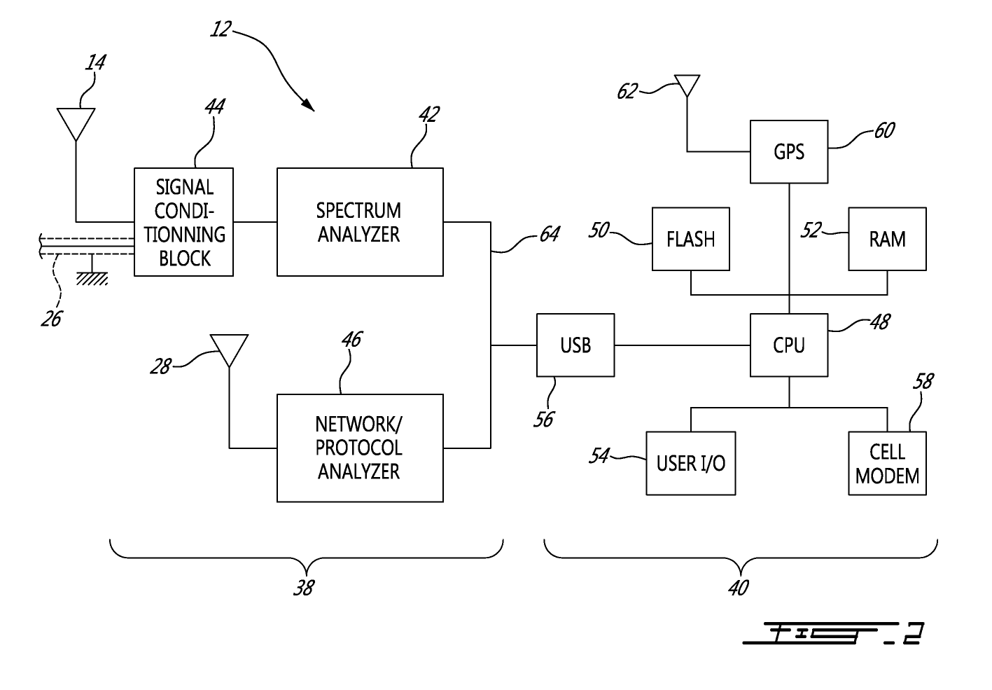

Referring now to FIG. 2, the monitoring unit 12 is generally divided into an interference signal reception part 38 and a recorded signal processing part 40. The interference signal reception part 38 comprises a spectrum analyzer 42 which receives and processes RF signals received at the input port, either from the first antenna 14 or the coaxial cable 26, illustratively via an analog front end signal conditioning block 44, and subsequently transfers the processed signals to the recorded signal processing part 40 for transmission to the server system (reference 30 in FIG. 1). The analog front end signal conditioning block 44 adapts the dynamic range of the monitored signals to that of the spectrum analyzer 42. The interference signal reception part 38 further illustratively comprises a network/protocol analyzer 46 which receives and processes the content of transmissions received at the second antenna 28 and subsequently transfers the processed transmissions to the recorded signal processing part 40 for transmission to the server system 30.

The recorded signal processing part 40, illustratively in the form of a thin client, comprises a CPU 48, FLASH Memory 50, comprising operating software and configuration software for the spectrum analyzer 42, RAM 52 for transitory data storage as well as a User I/O Interface 54 for initial set up and configuration. A USB interface 56 is provided for communicating with peripheral devices, for example keyboards, Wifi devices and the like (not shown). Additionally, a cellular modem interface 58 is provided for communicating via the cellular network (reference 32 in FIG. 1) with the server system 30. The amount of available RAM 52 would typically be selected to allow for limited operation during network outages, or in a standalone mode of operation where the monitoring unit 12 is not connected to the server system 30. In a particular embodiment a local hard drive (not shown) connected via a USB port or the like could be added to extend the localized storage capabilities.

Still referring to FIG. 2, in a particular embodiment a GPS receiver 60 and associated GPS antenna 62 is provided in order to provide monitoring unit location information and, if so required, an accurate clock signal for time stamping data and the like. Additionally, in order to provide stand alone off-grid operation, for example in remote locations, a battery (not shown) could be included to power the monitoring unit 12.

Still referring to FIG. 2, as will be understood to a person of ordinary skill in the art, the cellular modem interface 58, the GPS receiver 60 and in part the User I/O Interface 54 could eventually be provided via additional USB interfaces and appropriate hardware (all not shown). Indeed, it is foreseen that the recorded signal processing part 40 be provided in large part by a thin client such as an HP t5545 or the like with a customized operating system. As known in the art, such thin clients provide basic processing, interfacing and networking capabilities in a small, relatively inexpensive unit. Similarly, the interference signal reception part 38 is illustratively a standalone unit which communicates with the recorded signal processing part 40 via a USB connection 64. An exemplary embodiment of the interference signal reception part 38 is illustratively provided by a Signal Hound USB-SA44B. Note that thin clients typically include interfaces for peripheral devices such as keyboards and display monitors and the like (all not shown). An exemplary thin client as used to provide the present CPU function 48 would generally be operated in the absence of such peripheral devices, which would typically be used, if at all, only for initial set up and configuration.

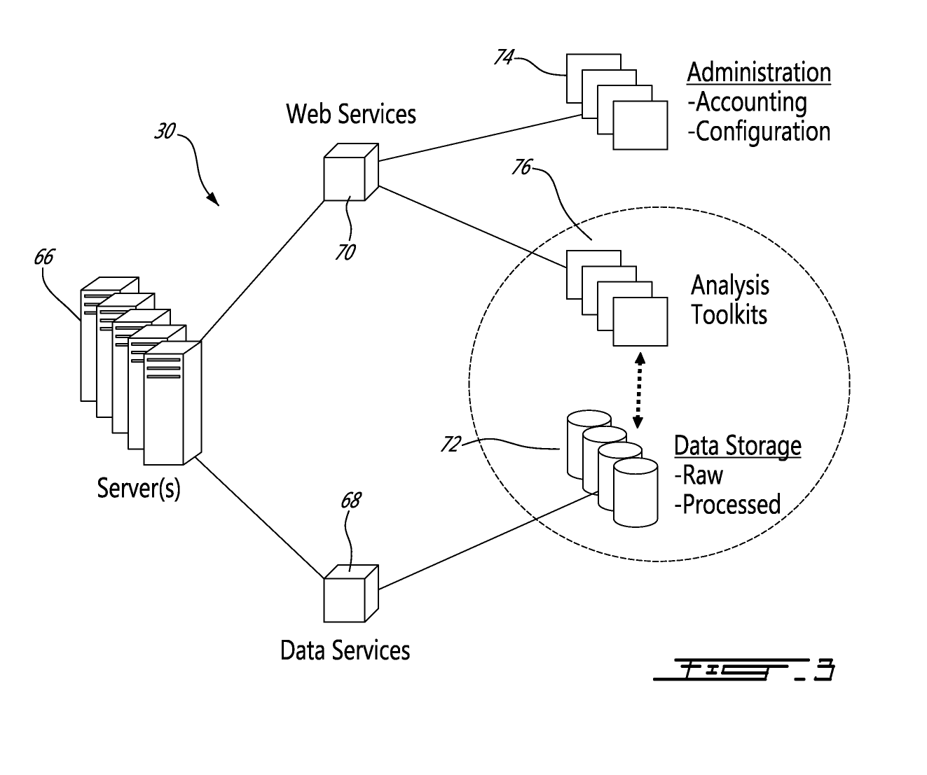

Referring now to FIGS. 1 and 3, the server system 30 is illustratively comprised of one or more servers 66 which together provide data services 68 and web services 70. Data services 68 includes, for example, the reception of monitoring data from the monitoring unit(s) 12 and the storage of that data in data storage 72 as well as provision of the necessary database structures and query compilers and the like. Illustratively, database services 68 are in part provided by a versatile SQL database/compiler. Additionally, some initial processing of monitoring data received from the monitoring unit could be carried out by the database services 68. Web services 70 are accessed by the user using a web browser or the like and comprise such applications as accounting and configuration 74 and the like. For example, configuration could be via a user interface and include configuring the various frequency ranges, transmission protocols and the like to be used for subsequent monitoring by the monitoring unit 12, as well as the period of time during which the monitoring unit 12 should gather data. Once configured, the monitoring unit 12 would then typically run autonomously and deliver a stream of monitoring data or packets of monitoring data on a timely basis to the server system 30. Typically, the data format used to transmit the samples would include a time stamp derived, for example, from the GPS clock signal.

Referring now to FIG. 2 in addition to FIG. 3, location of the monitoring unit 12 and the like derived from the GPS receiver 60 could also be included as well as the particular configuration settings of the spectrum analyzer 42 and the protocol analyzer 46. Note that although configuration is shown as being provided by the server system 30, in a particular embodiment configuration of one or other of the elements of the monitoring unit could be configured by direct remote access by the user 36 to the monitoring unit 12 or directly on the monitoring unit 12 through provision of a keyboard, mouse, display monitor (all not shown) and the like attached to the monitoring unit 12. The user also has access to a collection of analysis toolkits 76 for use when analyzing monitoring data stored in the one or more databases of the data storage 72.

Still referring to FIG. 2 in addition to FIG. 3, toolkits as in 76 can include, for example, software tools for extracting, processing and displaying monitoring data held within data storage 72. In this regard, monitoring data held within data storage 72 would include, for example, sampled data points of the signals received at the first antenna 14 of the monitoring unit 12 and processed by the spectrum analyzer 42 according to its configuration transmissions received at the second antenna 28 and processed by the protocol analyzer 46, as well as location and time stamps associated with the monitoring unit 12. Additionally, further processed versions of the sampled data points could be included within data storage 72.

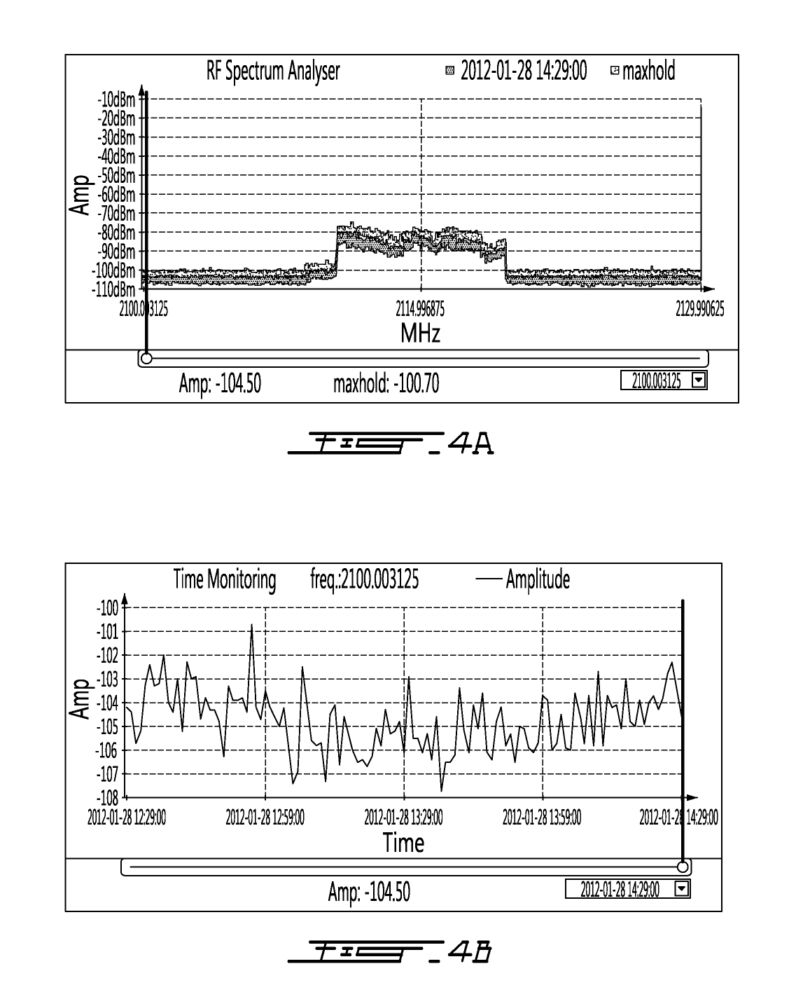

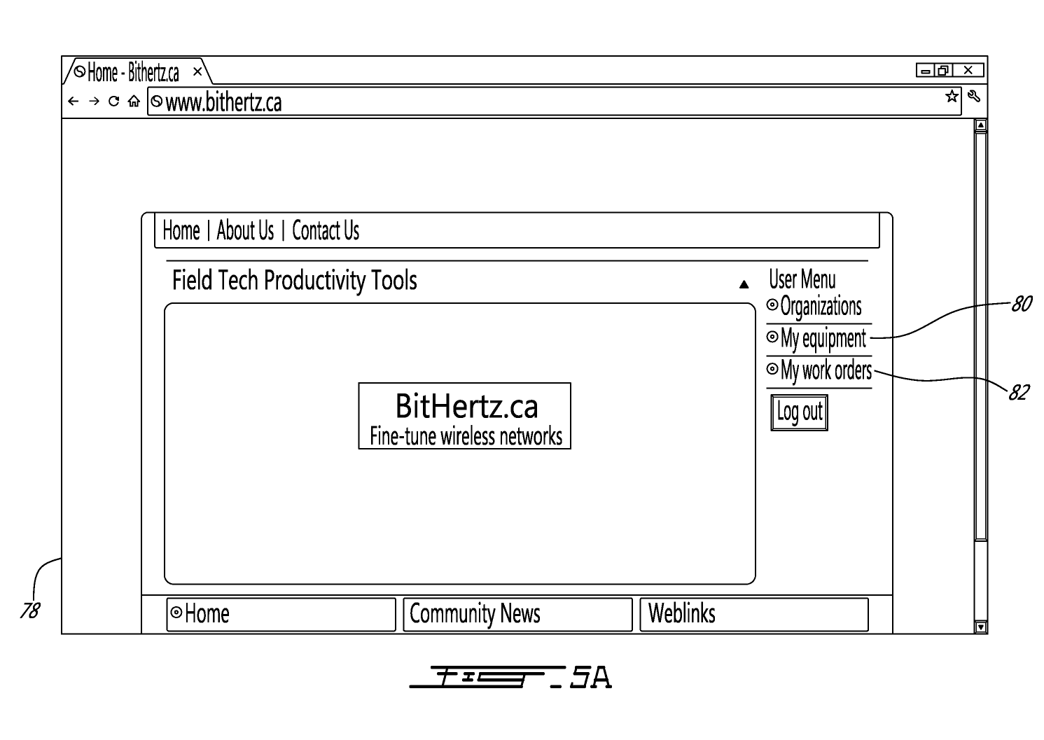

Referring to FIGS. 4A and 4B, typical toolkits would include those such as a spectrum analyzer tool (FIG. 4A) and a trace analyzer tool (FIG. 4B). As known the art, the spectrum analyzer tool of FIG. 4A allows the user to view signal amplitude versus frequency at a particular point in time. Such spectrums will be retrieved from the spectral data recorded in the databases 72 from the spectrum analyzer of the monitoring device. Typically the user would be able to display data using the spectrum analyzer tool over the time period the monitoring data has been collected and be provided with additional tools in order to manipulate the date, for example tools allowing repeated viewing of limited time segments and pausing during display of the particular time segment and the like. Additionally, tools would be provided to indentify signals in particular sub-bands, for example with user selected colors or line types or the like.

The trace analyzer tool of FIG. 4B on the other hand allows the user to view the amplitude of the signal transmitted on a specific frequency band versus time from the interpolation of amplitudes of that specific frequency found in the series of spectrum displays recorded in that time interval. The signals can be denominated with names as Tx frequency or Rx frequency or by their frequency values, as shown. Additionally, as discussed above recorded signals in particular sub-bands can be coded in order to aid the user in distinguishing between valid communication signals and those signals which may be causing interference.

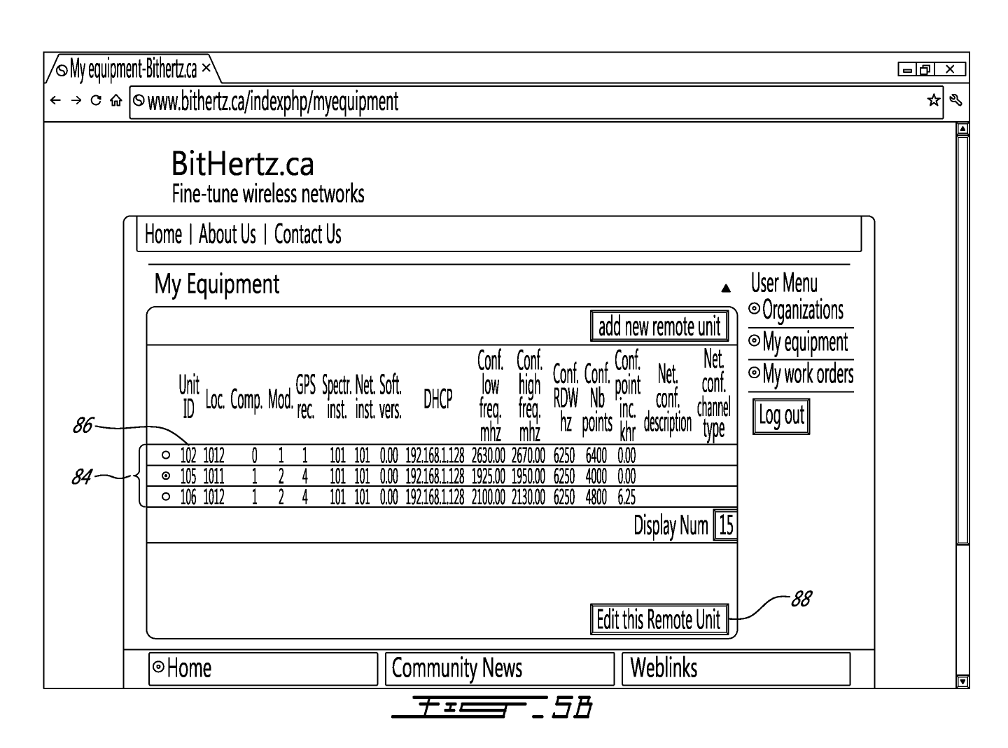

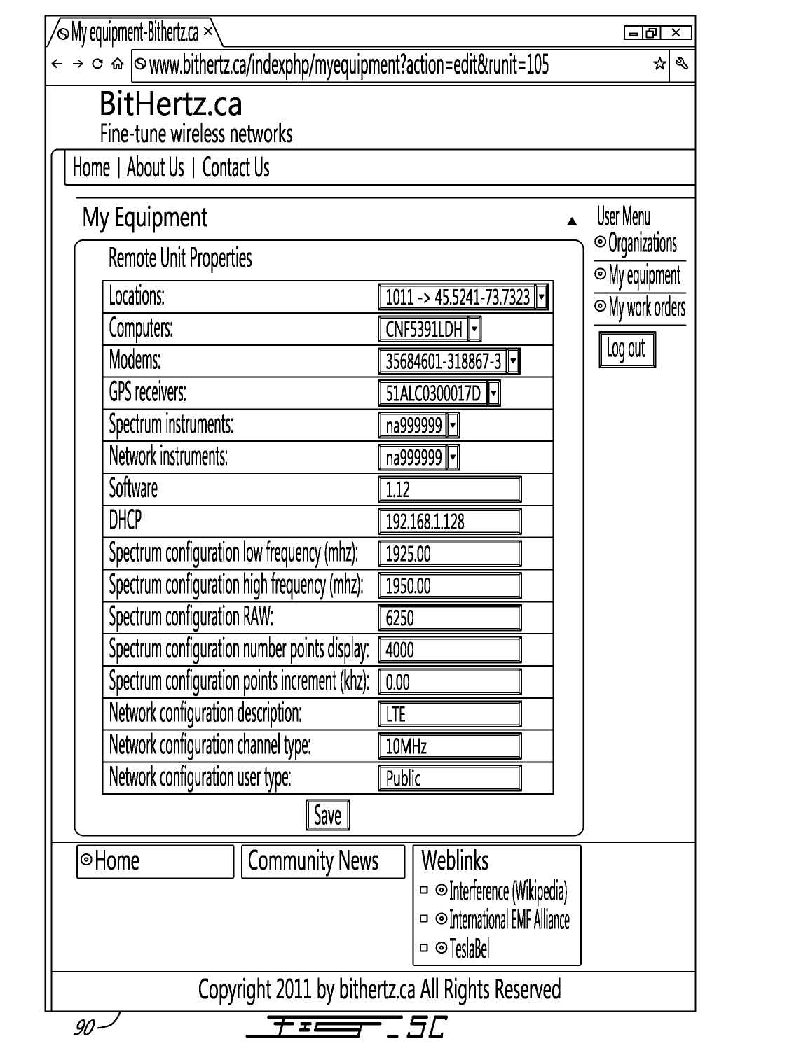

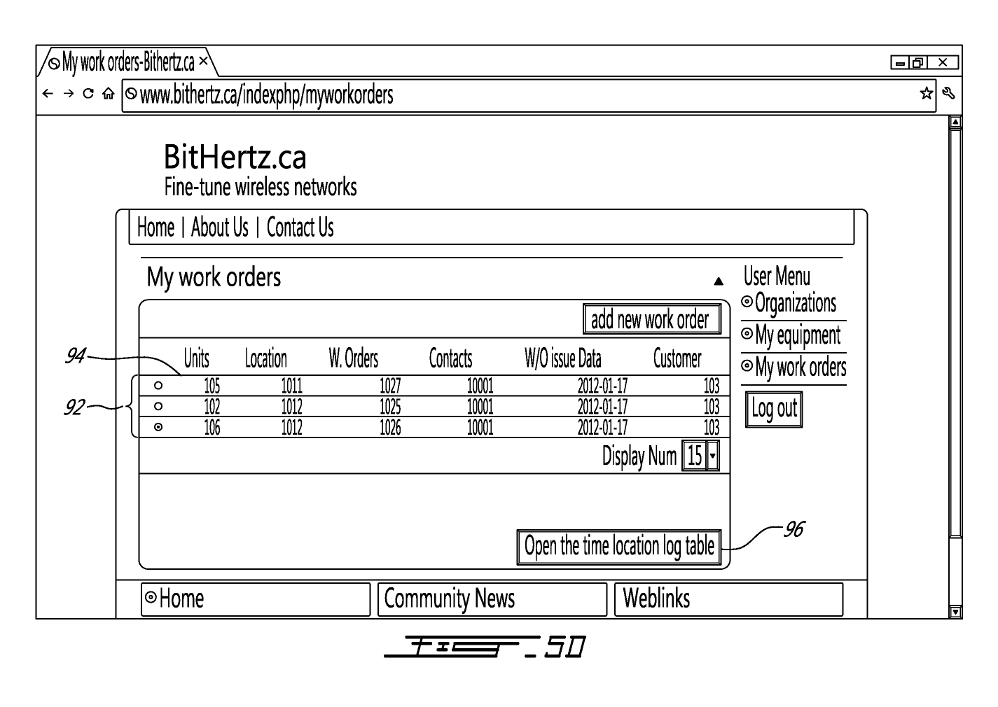

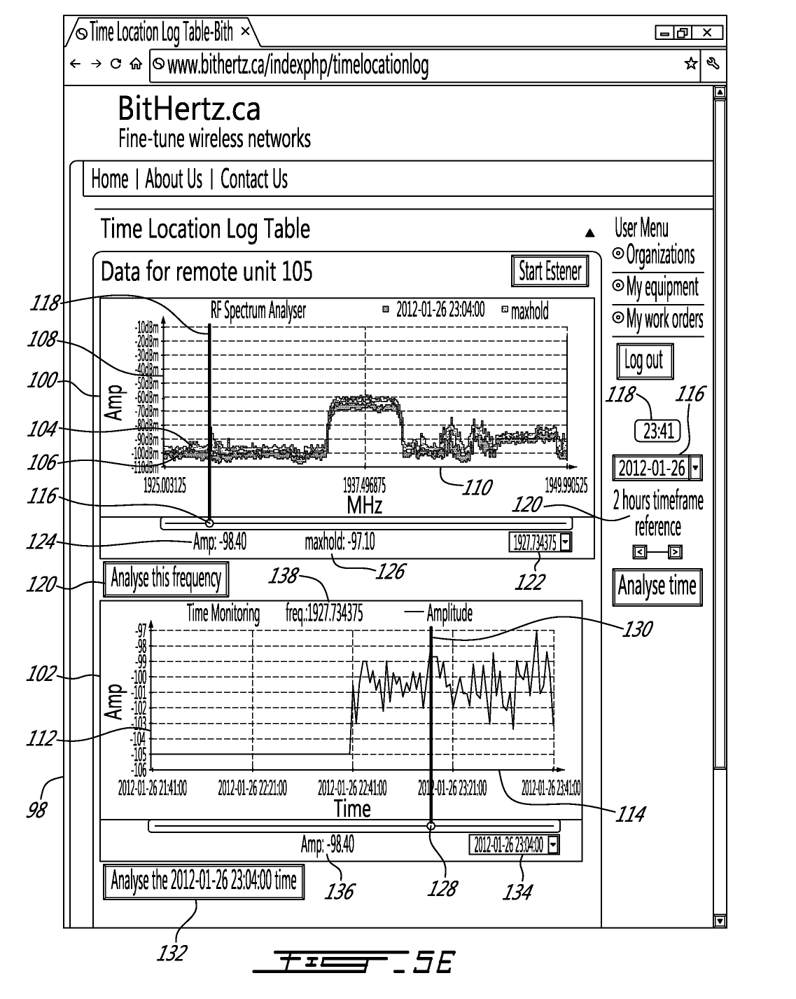

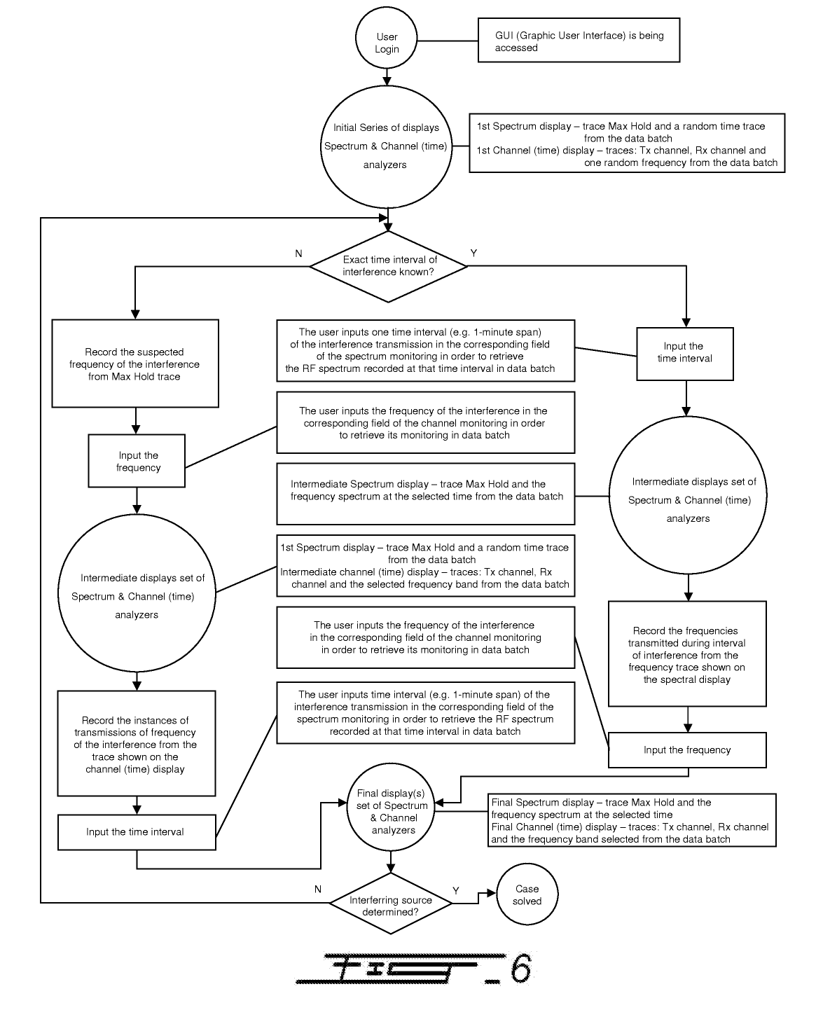

Referring now to FIGS. 5A through 5E in addition to FIG. 3, as discussed above a user typically gains access to the Web Services 70 and the analysis tools kits 76 via a web interface. Referring to FIG. 5A, a user gains initial access by logging onto the Web Services 70 where he is presented with a main screen 78 which provides user selectable options, for example equipment 80 or work order 82. On selecting the equipment option 80, and with reference to FIG. 5B, the user is presented with an itemized list 84 of the units as in 86 which are currently installed and available for configuration. The user may opt to edit the unit by selecting the appropriate button 88 following which they will be presented with a remote unit property screen 90 (FIG. 5C) which lists the properties of the various components of the selected equipment. Properties illustratively include:
Location of the remote unit (illustratively used herein as reference for the location data provided by the GPS receiver 60);
model number of the remote unit thin client 48;
model number of the remote unit modem 58;
model number of the remote unit GPS receiver 60;
model number of the remote unit spectrum analyzer 42;
model number of the remote unit protocol analyzer 46
version Number of the software in use by the remote unit thin client 48;
IP address of the remote unit thin client 48;
frequency band setting of the spectrum analyzer 42, provided by a low frequency setting and a high frequency setting;
Resolution Band Width (RBW) setting of the spectrum analyzer 42;
number of points of spectrum display;
increment (illustratively in kHz) of each of the points of spectrum display;
network configuration type;
network channel type;
network user type, etc.

Referring back to FIG. 5A, on selecting the work order 82 option the user is presented with an itemized list 92 of work orders 94 (see FIG. 5D). The user may opt to view the results of one or other of the work orders 94 by selecting the work order 94 and the appropriate button 96 following which the results of the work order, referred to as the time location log table 98, will be graphically displayed (see FIG. 5E).

Still referring to FIG. 5E, the time location log table comprises two interactive displays, with illustratively the upper display 100 presenting the results of a frequency domain (spectrum) analysis at a particular point in time and within at least a portion of the frequency band selected using the equipment property screen 90, and the lower display 102 providing a time domain representation of a particular frequency over the time frame in question. Illustratively, the upper spectrum display 100 provides both a maximum hold spectrum 104 over the time frame as well as the current spectrum 106 at the selected point in time. The y-axis 108 of the upper spectrum display 100 is divided into units of decibels (dB) and the x-axis 110 in units of frequency. Similarly, the y-axis 112 of the lower time domain display 102 is also in dB and the x-axis 114 in time.

The time frame, which also provides the x-axis 114 of the lower time display 102, represents the time during which the max hold function was performed for data acquired and displayed regarding a particular work order, and is indicated with reference to the date field 116, the time of ending of the data display 118 as well as the time frame reference 120 (here illustratively two hours). The time of ending of the time frame reference can be changed in order to include the whole data acquisition time interval of the particular work order.

Still referring to FIG. 5E, the spectrum display 100 and the time domain display 102 are linked such that, when a particular frequency is selected along the spectrum display x-axis 110 the corresponding time domain signal is retrieved and displayed on the time domain display 102. Similarly, when a particular time point is selected long the time domain display x-axis 114 the current spectrum is retrieved for that particular point in time. Illustratively, a particular point on the frequency spectrum x-axis 110 is selected by moving a first slider 116 and corresponding first cursor 118 along the spectrum x-axis 110 to a point of interest whose frequency value is shown in box 122 and subsequently selecting the “analyse this frequency” button 120, thereby causing the time domain display 102 to be updated accordingly. Alternatively the frequency can be selected using a frequency drop down box 122. Coincidentally, the amplitude in dB 124 and the maximum hold in dB 126 at the selected frequency are also displayed. Similarly, a particular point on the time domain x-axis 114 is selected by moving a second slider 128 and corresponding second cursor 130 along the time domain x-axis 114 to a point of interest and subsequently selecting the “analyse the . . . time” button 132, thereby causing the spectrum display 100 to be updated accordingly. Alternatively the time point of interest can be selected using a time instant drop down box 134. Coincidentally, the amplitude in dB 136 and the selected frequency 138.

Using the above pair of linked interactive displays 100, 102, the user can quickly identify and analyze interfering signals.

In operation, each monitoring unit would be installed in accordance with the preferences of its respective user, for example in a particular location or the like and potentially with specific equipment, such as customized antennas or the like. Additionally, parameters such as frequency bands for recording, duration of recording and the like could also be determined according to the preferences of the user. Each user would typically be provided with a specific duration of recorded data, for example 120 minutes, and would examine the recorded monitoring data using the spectrum analyzer tool in order to identify potentially interfering signals and identify these versus valid communication signals, for example as discussed using an appropriate color coding or the like. Subsequently, the identified signals could be examined using the trace analyzer tool to better determine the origin of the interfering signals. A typical usage would be as follows:
User logs into the system via the web services interface 70;
the browser displays the recorded data one two screens 100, 102, one showing the frequency domain at discrete points of time and the other showing the time domain over a period of time for particular frequencies;
the user modifies the fields until significant data is retrieved (frequency of interest, time period of interest, etc.);
the user can at any time print the displays, for example to pdf or the like, for later analysis or viewing;
a network log is available which would typically include supporting data such as unit location, configuration settings, time stamps, which would also be available via a printed report;
in one embodiment, a limited of recorded data is maintained on the server system, and it is refreshed automatically after a certain time period, for example every 15 minutes, where the oldest 15 minutes of data are flushed from the system;
in another embodiment, all recorded data is maintained and made available to the user;
If there is no usage of the browser after a period of time, illustratively 30 minutes, the user is automatically logged off.

Reference may also be made to FIG. 6, which provides a typical series of operations carried out by a user in order to determine interference.

The use of a remote monitoring facility as described also has the advantage that the user can advantageously adjust the parameters of his own system in a timely manner while collecting data through one or more remote monitoring units as in 12, thereby simplifying the detection of the one or more interference sources as in 24.

Referring back to FIGS. 1 and 3, in addition to accounting and configuration, web services 70 could also include other services such as service charge calculation and invoicing. Indeed, in a particular embodiment it is foreseen that the user(s) as in 36 would subscribe to a monitoring service provided, for example, by the owner of the server subsystem 30, who would also own and loan or lease one or more monitoring units as in 12 to the users as in 36. The user would be levied fees based on one or a combination of:
Monthly subscription;
monitoring unit rental; and
time logged into the system, etc.

In a particular embodiment, the user would be charged based on a measured usage such monitoring unit usage, data services usage (for example storage used) and web services usage (for example access to particular tools or time logged into system).

Although the present invention has been described hereinabove by way of specific embodiments thereof, it can be modified, without departing from the spirit and nature of the subject invention as defined in the appended claims.

1. An apparatus for analyzing and monitoring interference in a source of radio frequency (RF) signals, the apparatus comprising:
a monitoring device comprising an antenna and spectrum analyzer for collecting a series of RF signals within a frequency band and over a time frame from the source of RF signals;
data storage for storing said collected RF signals;
a first display for presenting a frequency spectrum of said collected RF signals over said frequency band and at a display time within said time frame;
a second display for presenting a time domain representation of said collected RF signals over said time frame and for a display frequency within said frequency band; and
an interface for modifying one of said display frequency and said display time;
wherein modification of said display frequency results in said time domain representation being accordingly updated and modification of said display time results in said frequency spectrum being accordingly updated.

2. The apparatus of claim 1, wherein said first display comprises a graphical representation of said frequency spectrum in a form of amplitude in dB on a vertical axis and frequency on a horizontal access and said second display comprises a graphical representation of said time domain presentation in a form of amplitude in dB on a vertical axis versus time on a horizontal axis.

3. The apparatus of claim 1, wherein said interface comprises a cursor and further wherein said display frequency is modified by selecting a frequency on said presented frequency spectrum and said display time is modified by selecting a time on said time domain representation.

4. The apparatus of claim 3, wherein said selecting a frequency on said presented frequency spectrum comprises clicking on said presented frequency spectrum and said selecting a time on said time domain representation comprises clicking on said presented time domain representation.

5. The apparatus of claim 1, wherein said interface comprises a pair of slideable cursors, wherein selecting a frequency on said presented frequency spectrum comprises sliding a first of said slideable cursors along a frequency axis of said presented frequency spectrum and said selecting a time on said time domain representation comprises sliding a first of said slideable cursors along a time axis of said presented time domain representation.

6. The apparatus of claim 1, wherein said collected RF signals comprise a series of samples of said frequency RF signals.

7. The apparatus of claim 1, wherein said first display further presents a maximum hold representation of said frequency spectrum of said collected RF signals over said frequency band and said time frame.

8. A method for analyzing and monitoring interference in a source of radio frequency (RF) signals comprising:
collecting and storing RF signals within a frequency band and over a time frame;
presenting on a first display a frequency spectrum of said stored RF signals over said frequency band and at a display time within said time frame;
presenting on a second display a time domain representation of said stored RF signals over said time frame and for a display frequency within said frequency band;
locating one of a frequency of interest and a time of interest and accordingly modifying one of said display frequency to said frequency of interest and said display time to said time of interest;
wherein modification of said display frequency results in said time domain representation being accordingly updated and modification of said display time results in said frequency spectrum being accordingly updated.

9. The method of claim 8, wherein said frequency spectrum is displayed in a form of amplitude in dB on a vertical axis and frequency on a horizontal access and said time domain presentation is displayed in a form of amplitude in dB on a vertical axis versus time on a horizontal axis.

10. The method of claim 8, further comprising repeating said locating one of said frequency of interest and said time of interest and said modifying one of said display frequency to said frequency of interest and said display time to said time of interest.

11. The method of claim 8, wherein said modifying said display frequency to said frequency of interest comprises moving a cursor on said displayed frequency spectrum to said frequency of interest and clicking on said frequency of interest.

12. The method of claim 8, wherein said modifying said display time to said time of interest comprises moving a cursor on said displayed time domain representation to said time of interest and clicking on said time of interest.

13. A system for monitoring and analyzing interference in a source of RF signals, the system comprising:
at least one monitoring device, each monitoring device comprising an antenna and a spectrum analyzer for collecting a series of RF signals from the source of RF signals over a time frame and within a frequency band, a processor for time stamping said collected series of RF signals and a network interface for transmitting said time stamped series of RF signals to a server system;
said server system comprising a data services part comprising a databank for storing said time stamped series of RF signals and a web services part comprising a web interface comprising a plurality of analysis tools; and
at least one user system, said user system comprising a web browser for accessing said server system using said web interface for accessing at least one of said plurality of analysis tools for analyzing a respective series of said time stamped series of RF signals stored in said databank.

14. The system of claim 13, further comprising a coaxial cable interconnecting said antenna and said spectrum analyzer.

15. The system of claim 13, further comprising a signal conditioning block interconnected between said antenna and said spectrum analyzer, said signal conditioning block adjusting a dynamic range of the source of RF signals to a dynamic range of said spectrum analyzer.

16. The system of claim 13, further comprising an accounting sub-system for measuring a usage of at least one of said monitoring unit, said data services part and said web services part and invoicing said user based on said measured usage.

17. The system of claim 13, wherein said web interface further comprises a configuration tool for selecting said time frame and said frequency bandwidth of each of said at least one monitoring unit.

18. The system of claim 13, wherein said monitoring unit further comprises a GPS receiver for determining a unit location, wherein said monitoring unit location is transmitted to said server system via said network interface and further wherein said monitoring unit location is stored within said databank.

19. The system of claim 13, wherein said plurality of analysis tools comprises a spectrum analyzer display for presenting a frequency spectrum of said stored series of RF signals over said frequency band and at a display time within said time frame and a time domain analysis display for presenting a time domain representation of said stored series of RF signals over said time frame and for a display frequency within said frequency band and a control object for selecting one of a frequency on said frequency spectrum as said display frequency and a time on said time domain representation as said display time, and further wherein selection of said frequency as said display frequency results in said time domain representation being accordingly updated and selection of said time as said display time results in said frequency spectrum being accordingly updated.
